(19) United States
(12) Patent Application Publication
(10) Pub. No.: US 2016/0071496 A1
(43) Pub. Date: Mar. 10, 2016

(54) ALIGNING CONTENT ITEMS WITH MAP FEATURES

(71) Applicant: Google Inc., (US)

(72) Inventors: Jonah Jones, Sydney New South Wales (AU); Patrick Hofmann, Darlinghurst New South Wales (AU)

(73) Assignee: Google Inc., Mountain View, CA (US)

(21) Appl. No.: 13/649,790

(22) Filed: Oct. 11, 2012

(51) Int. Cl. G09G 5/377; G06F 3/0484; G06T 19/00; G06T 3/00; G09G 5/02; H04N 5/445

(52) U.S. Cl. CPC G09G 5/377; H04N 5/44504; G06T 19/003; G06T 3/0006; G06F 3/04845; G09G 2340/12

(57) ABSTRACT

This specification describes technologies relating to aligning content items with map features. In general, one aspect of the subject matter described in this specification can be embodied in methods that include receiving a request for an online map and selecting a shape in the online map to accommodate overlay of a content item. The methods may further include scaling a content item to fit the shape and aligning the content item with an edge of the shape. The methods may further include rendering the map with the content item projected onto the shape and transmitting data encoding the rendered map in response to the request.

### BACKGROUND

This disclosure relates generally to integrating content items into online maps.

In an online mapping system, polygons, polylines, and vector graphics generally can be specified by a collection of vertices, with each vertex representing a map location defined by map coordinates. The resulting vector graphic can be rendered in various ways and is typically composited with an underlying map image.

Labels or pins may be added to a map to describe places depicted in the map. Labels or pins may obscure features of map.

### SUMMARY

This specification describes technologies relating to aligning content items with map features. In general, one aspect of the subject matter described in this specification can be embodied in a method that includes receiving, using one or more data processing apparatuses, a request for an online map. The method may further include selecting, using one or more data processing apparatuses, a shape in the online map to accommodate overlay of a content item. The method may further include scaling, using one or more data processing apparatuses, a content item to fit the shape. The method may further include aligning, using one or more data processing apparatuses, the content item with an edge of the shape. The method may further include rendering, using one or more data processing apparatuses, the map with the content item projected onto the shape. The method may further include transmitting, using one or more data processing apparatuses, data encoding the rendered map in response to the request.

In general, one aspect of the subject matter described in this specification can be embodied in a system that includes a data processing apparatus and a memory coupled to the data processing apparatus. The memory having instructions stored thereon which, when executed by the data processing apparatus cause the data processing apparatus to perform operations including receiving a request for an online map. The operations may further include selecting a shape in the online map to accommodate overlay of a content item. The operations may further include scaling a content item to fit the shape. The operations may further include aligning the content item with an edge of the shape. The operations may further include rendering the map with the content item projected onto the shape. The operations may further include transmitting data encoding the rendered map in response to the request.

In general, one aspect of the subject matter described in this specification can be embodied in a system that includes a server system interface configured to receive a request for an online map. The system may further include a module configured to select a shape in the online map to accommodate overlay of a content item. The system may further include a module configured to scale a content item to fit the shape. The system may further include a module configured to align the content item with an edge of the shape. The system may further include a module configured to render the map with the content item projected onto the shape. The system may further include a server system interface configured to transmitting data encoding the rendered map in response to the request.

In general, one aspect of the subject matter described in this specification can be embodied in a computer readable storage media storing software including instructions executable by a processing device that upon such execution cause the processing device to perform operations that include receiving a request for an online map. The operations may further include selecting a shape in the online map to accommodate overlay of a content item. The operations may further include scaling a content item to fit the shape. The operations may further include aligning the content item with an edge of the shape. The operations may further include rendering the map with the content item projected onto the shape. The operations may further include transmitting data encoding the rendered map in response to the request

In general, one aspect of the subject matter described in this specification can be embodied in a method that includes transmitting, using one or more data processing apparatuses, a request for an online map. The method may further include selecting, using one or more data processing apparatuses, a shape in the online map to accommodate overlay of a content item. The method may further include receiving, using one or more data processing apparatuses, a content item for integration into the online map. The method may further include scaling, using one or more data processing apparatuses, the content item to fit the shape. The method may further include aligning, using one or more data processing apparatuses, the content item with an edge of the shape. The method may further include rendering, using one or more data processing apparatuses, the map with the content item projected onto the shape. The method may further include presenting, using one or more data processing apparatuses, the map to a user.

In general, one aspect of the subject matter described in this specification can be embodied in a system that includes a data processing apparatus and a memory coupled to the data processing apparatus. The memory having instructions stored thereon which, when executed by the data processing apparatus cause the data processing apparatus to perform operations including transmitting a request for an online map. The operations may further include selecting a shape in the online map to accommodate overlay of a content item. The operations may further include receiving a content item for integration into the online map. The operations may further include scaling the content item to fit the shape. The operations may further include aligning the content item with an edge of the shape. The operations may further include rendering the map with the content item projected onto the shape.

In general, one aspect of the subject matter described in this specification can be embodied in a system that includes a wireless network interface configured to transmit a request for an online map. The system may further include a module configured to select a shape in the online map to accommodate overlay of a content item. The system may further include a wireless network interface configured to receive a content item for integration into the online map. The system may further include a module configured to scale the content item to fit the shape. The system may further include a module configured to align the content item with an edge of the shape. The system may further include a module configured to render the map with the content item projected onto the shape. The system may further include a display interface configured to present the map to a user.

In general, one aspect of the subject matter described in this specification can be embodied in a computer readable storage media storing software including instructions executable by a processing device that upon such execution cause the processing device to perform operations that include transmitting a request for an online map. The operations may further include selecting a shape in the online map to accommodate overlay of a content item. The operations may further include receiving a content item for integration into the online map. The operations may further include scaling the content item to fit the shape. The operations may further include aligning the content item with an edge of the shape. The operations may further include rendering the map with the content item projected onto the shape. The operations may further include presenting the map to a user.

These and other embodiments can each optionally include one or more of the following features. The content item may describe something other than a place in a geographic region depicted in the map. A content item may be selected for integration into the online map. Selecting the content item may include running an auction. Selecting the content item may include selecting the content item at least in part based on a display feature of the content item and a geometric feature of the shape. Selecting the shape may include selecting the shape at least in part based on a comparison of a geometric feature of the shape and a display feature of the content item. Selecting the shape may include selecting a shape that has been previously identified as virtual billboard location. Selecting the shape may include determining scores for shapes based at least in part on geometric features of those shapes. Selecting the shape may include determining scores for shapes based at least in part on color or texture features of those shapes. Selecting the shape may include determining scores for shapes based positions of those shapes within the online map. Selecting the shape may include biasing for the selection of shapes positioned near an edge of the online map.

Particular embodiments can be implemented to realize none, one or more of the following advantages. Some implementations may integrate content items in the main view of a map, even where the content item is not directly related to a location depicted in the map. Some implementations may avoid user confusion by leveraging people's understanding from experience with physical billboards. Some implementations may avoid obscuring map features when overlaying a content item in the map.

The details of one or more embodiments are set forth in the accompanying drawings and the description below. Other features, aspects, and advantages will become apparent from the description, the drawings, and the claims.

### BRIEF DESCRIPTION OF THE DRAWINGS

FIG. 1 is a block diagram of an example online environment.

FIG. 2 is a flow chart of an example process for rendering a map with an integrated content item that is aligned with a shape in the map.

FIGS. 3A-3D are example maps that may be generated using the process depicted in FIG. 2.

FIG. 4 is a block diagram of example computer systems that can be used to render a map with an integrated content item that is aligned with a shape in the map.

### DETAILED DESCRIPTION

### Definitions

The term “content item” as used herein encompasses its plain and ordinary meaning, including any data that can be provided over a network that includes a visual component for display to a user. For example, an advertisement, including a link to a landing page is a content item. Another example of a content item is an offer for the purchase of a service or deal. Multiple deals or advertisements may even be displayed together as a single content item. In some cases, the visual component of a content item may be referred to as a creative. The processes described below are illustratively applied to content items that are advertisements provided in response to a request for a map, but the processes are also applicable to other content items provided over a network.

The term “render” as used herein encompasses its plain and ordinary meaning, including, but not limited to, generating an image from data including one or more models of objects to be depicted in the image.

The term “online map” as used herein encompasses its plain and ordinary meaning, including, but not limited to, a map that is accessible through a network and rendered, at least in part, in real time in response to a request.

The term “computing device” as used herein encompasses its plain and ordinary meaning, including, but not limited to, an appropriate processor and/or logic that is capable of receiving and storing data, and of communicating over a network.

### Overview

An online mapping service provides requested maps with integrated content items (e.g., advertisements) for presentation to a user. It may be useful to pair content items with maps, even where the content items do not reflect places depicted in the map. For example, it may be useful to present an advertisement for a restaurant review and rating service in map that is generated in part in response to a search for restaurants in a geographic area. A content item may be integrated into a map in a relatively unobtrusive manner by identifying and selecting relatively unused space in the map and aligning an image for the content item with the geometric features of that space. For example, integrated content item may be created by projecting an advertisement image onto a surface depicted in a map.

A content item may be overlaid on various types of shapes within a map. For example, shapes could include polygons used to represent geographic features (e.g., a body of water), polygons used to represent architectural features (e.g., a wall or roof of a building), or space between other features in map (e.g., the space between roads depicted in the map). The process of scaling and aligning an image for a content item to match a shape in a map may be referred to as snapping the content item to the shape. Snapping a content item to a shape may reduce the extent to which significant features of the map are obscured by the content item when its visual component is overlaid. For example, snapping may include virtually affixing the content item to the shape so that the visual component of the content item is rendered in the same relative position to the shape regardless of the viewpoint from which the map is rendered.

Shapes may be selected for snapping of a content item in a variety of ways. In some implementations, shapes are identified and evaluated in response to a request by comparing features of the shapes occurring in a requested map view. For examples, geometric, texture, or color features of shapes in the map may be compared to select the best shape or shapes for overlay. In some implementations, one or more shapes in a map may be identified before a request is received. For example, the wall of a building depicted in 3 dimensional (3-D) maps may identified as candidate shape and an advertiser may purchase the ongoing right to have their advertisements displayed on the wall whenever the wall appears in a user requested map.

A content item may be selected for integration into a requested map. A request for an online resource that includes a map may create one or more opportunities to present content items to a user. Selection of a content item for presentation in response to a resource request is interchangeably referred to as allocation of an impression to the selected content item (e.g., an advertisement).

The value of an allocation may be estimated based on information about the impression and the content item. For example, relevant information about an impression may include the geometric dimensions of the available display space (e.g., geometric features of a shape in the map), information about other content in the requested online resource (e.g., text from labels or pins in a map or a query used to generate a map), the time of the request, data about the user who made the request (e.g., cookies, geographic location, etc.), etc. Information about the content item may include keywords associated with the content item. A content or advertisement allocation system may seek to allocate impressions to content items in a manner that enhances the estimated value of the allocations. In some implementations, a score used for selection of content items may be based in part on an estimate of the value of allocating an impression to a content item. In some implementations, an auction may be run in real-time to allocate an impression by selecting a content item with the highest bid.

### Example System Implementations

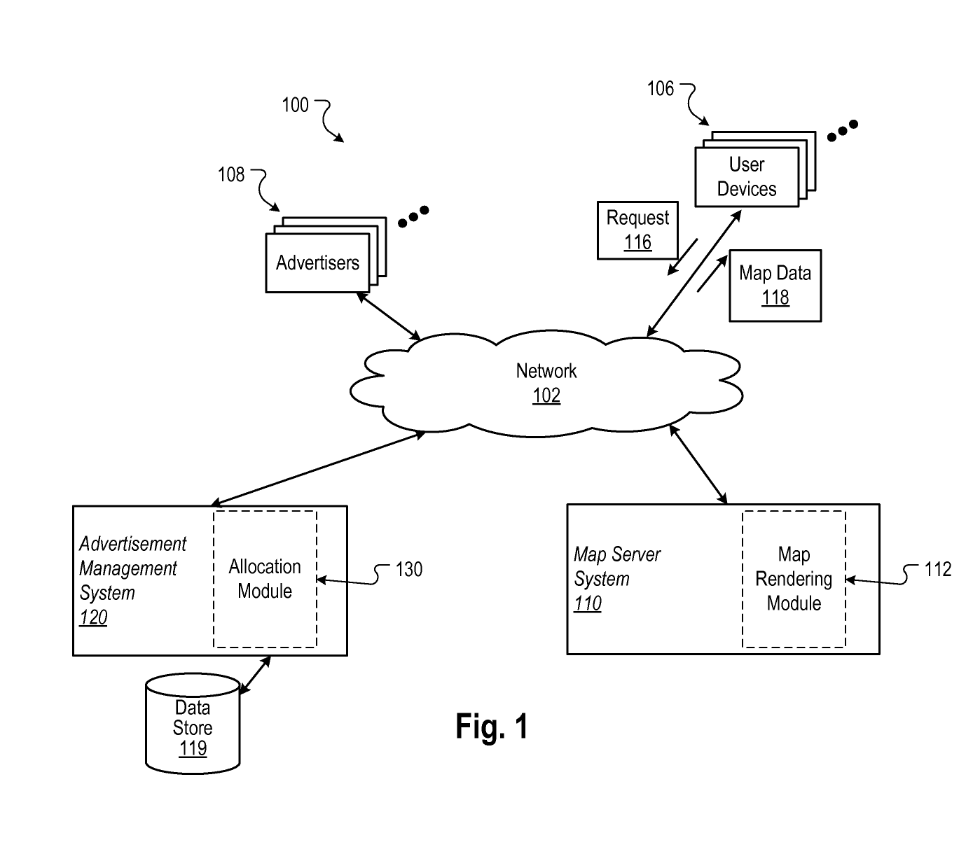

FIG. 1 is a block diagram of an example online environment 100 in which a map server system 110 responds to requests for maps by transmitting data reflecting maps with integrated content items (e.g., advertisements). The example environment 100 includes a network 102, e.g., a local area network (LAN), wide area network (WAN), the Internet, or a combination thereof. The network 102 connects user devices 106, content providers (e.g., advertisers 108), an advertisement management system 120, and the map server system 110. The example environment 100 may include many thousands of user devices 106 and advertisers 108.

A user device 106 is an electronic device that is under control of a user and is capable of requesting and receiving resources, including map data 118, over the network 102. Example user devices 106 include personal computers, mobile communication devices, and other devices that can send and receive data over the network 102. A user device 106 typically includes a user application (e.g., a web browser) to facilitate the sending and receiving of data over the network 102 and the presentation of content to a user.

A user device 106 can submit requests 116 for resources including a map to the map server system 110. In turn, map data 118 representing the requested map can be provided to the user device 106 for presentation by the user device 106. The map data 118 may also include data specifying a portion of the resource or a portion of a user display in which advertisements or other content items can be presented.

When a map is requested by a user device 106, the advertisement management system 120 may receive a request for additional content items (e.g., advertisements) to be provided with the map data 118. The request for advertisements may include characteristics of the advertisement slots that are identified in requested map, and these requests are provided to the advertisement management system 120.

For example, the geometric dimensions of the advertisement slot can be provided to the advertisement management system 120. Similarly, terms associated with a requested map or a search query associated with the map can also be provided to the advertisement management system 120 to facilitate identification of advertisements that are relevant to the map.

Based on data included in the request for advertisements, the advertisement management system 120 can select advertisements that are eligible to be provided in response to the request (“candidate advertisements”). For example, candidate advertisements can include advertisements having characteristics matching the characteristics of advertisement slots and that are identified as relevant to a specified request 116.

The advertisement management system 120 can select from the candidate advertisements that are provided for presentation in advertisement slots of a map based on results of an auction. For example, the advertisement management system 120 can receive bids from advertisers 108 and allocate the advertisement slots to the highest bidders at the conclusion of the auction. The bids are amounts that the advertisers are willing to pay for presentation (or selection) of their advertisement in a map. For example, a bid can specify an amount that an advertiser 108 is willing to pay for each 1000 impressions (i.e., presentations) of the advertisement, referred to as a CPM bid. Alternatively, the bid can specify an amount that the advertiser is willing to pay for a selection (i.e., a click-through) of the advertisement or a conversion following selection of the advertisement. The highest bidders can be determined based on the bids alone, or based on the bids of each bidder being multiplied by one or more factors (e.g., quality scores).

A conversion occurs when a user performs a particular action related to an advertisement provided with a map. What constitutes a conversion may vary from case to case and can be determined in a variety of ways. For example, a conversion may occur when a user clicks (on a web page) or taps (on a mobile device) on an advertisement and is referred to a landing page. Another conversion may occur when a user consummates a purchase before leaving that landing page. A conversion can also be defined by an advertiser to be any measurable/observable user action. User actions may include, for example, downloading a white paper, navigating to at least a given depth of a website, viewing at least a certain number of web pages, spending at least a predetermined amount of time on a website or web page, registering on a website, etc. Other actions that constitute a conversion can also be used.

The advertisement management system 120 may store and access data regarding past allocations of content items and user interactions in a data store 119. The data store 119 is a data store that stores data representing previous user interactions with online resources and advertisements. For example, in response to receiving a request for an advertisement, the advertisement management system 120 can store data identifying the map or other resource to which the request corresponds. Additionally, the advertisement management system 120 can store data representing the advertisements that were provided in response to the request and any user actions (e.g., clicks or conversions) that are detected following presentation of the advertisements. The data store 119 may also store user session logs or cookies reflecting a user's browsing history.

The allocation module 130 may determine quality scores (e.g. predicted click through rates) for allocations of an impression to candidate content items based in part on weights for the online resource (e.g., map) in which the impression occurs. The quality scores may result from a blend of factors determined by matching characteristics (e.g., keywords) associated with a candidate content item to features (e.g., terms) occurring in the online resource or associated with the current user requesting the resource.

The allocation module 130 may select from among candidate content items based on quality scores. Data reflecting the selected content may be transmitted with a server system interface component of the advertisement management system 120 in response to a request for an impression.

In some implementations, the map server system 110 may receive an advertisement from the advertisement management system 120 or directly from an advertiser 108. A map rendering module 112 may be used to snap the advertisement to a shape in the requested map. The map rendering module 112 renders the map, resulting in map data 118 reflecting the map with the advertisement integrated. The map data 118 may then be transmitted to the user device 106 that requested the map.

In some implementations, data reflecting the advertisement may be sent directly to the user device 106 which may integrate the advertisement in a received map based on integration instructions in the received map data 118.

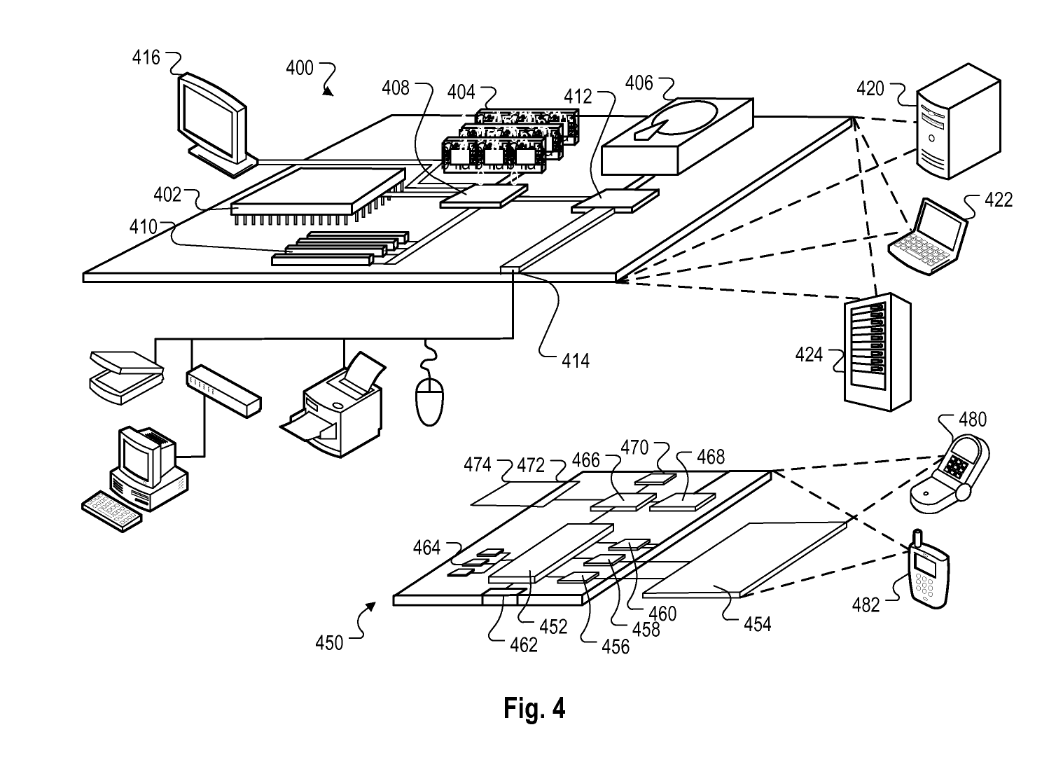

The map server system 110 may be implemented as software that is executed on a processing apparatus, e.g., a computer system described in FIG. 4. One or more server system interface components of the map server system 110 may be used to transmit map data 118 and receive requests 116 or advertisements. The advertisement management system 120 may also be implemented as software that is executed on a processing apparatus, e.g., a computer system described in FIG. 4. In some implementations, a map server system and a content management system (e.g., advertisement management system 120) may be implemented on the same processing apparatus.

### Example Processes

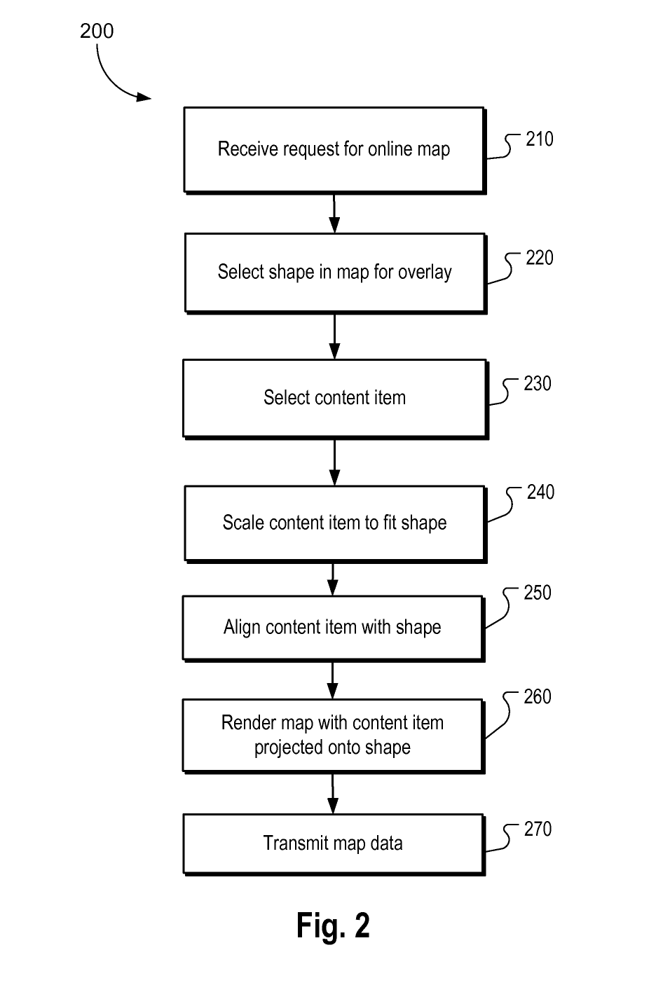

FIG. 2 is a flow chart of an example process 200 for rendering a map with an integrated content item that is aligned with a shape in the map. The process 200 selects a shape in the map to which a content item may be snapped. A content item may also be selected. The content item is snapped to the selected shape. The map may be rendered, resulting in map data representing the map with the content item overlaid on the selected shape. In some implementations, the map data may be transmitted to a user device for presentation to a user in response to a request. In some implementations, shape selection and map rendering may be performed on a user device and the rendered map may be directly presented to a user through a display.

The process 200 can be implemented, for example, by the map rendering module 112 in the map server system 110 of FIG. 1. In some implementations, the map server system 110 is a data processing apparatus that includes one or more processors that are configured to perform actions of the process 200. For example, the data processing apparatus may be the apparatus 400 described in FIG. 4. In some implementations, some of the steps in process 200 may be pushed out to a client device, e.g., a user device 106. For example, the mobile device 450 described in FIG. 4 may be a user device that selects a shape and renders the map with a received content item snapped to the shape. In some implementations, a non-transitory computer readable storage medium can include instructions that when executed by a computing device (e.g., a computer system) cause the device to perform actions of the process 200.

A request for an online map is received 210. The request may specify a geographic region that will be depicted in the map and other characteristics (e.g., display size, 2-D or 3-D, tilt angle of the map view, street view or satellite view, etc.) of the desired map. In some implementations, the request may include a search query. For example, a request may include a search for “hotels” in the specified geographic region. A map rendered in response to the request with this search query may include pins at locations of hotels in the region. In some implementations, the request may include information about a user making the request (e.g., a cookie).

The request may be received 210 from a user device (e.g., user device 106) over a network (e.g., network 102). For example, the request may be received using a network interface (e.g., server system interface components of the map server system 110). In some implementations, where the process 200 is mostly or entirely performed by a client device (e.g. user device 106), the request may be received via a user interface (e.g., a keyboard, keypad, touchpad, or pointing device interface). The request may be further transmitted to a remote map server system to acquire additional map data for use in rendering the requested map.

A shape in the requested map is selected 220 for overlay with a content item. Scores for shapes in the map may be determined and compared to select 220 the shape with the best characteristics for overlay of a content item. The scores may be based on one or more factors. For example, a shape selection score may be a linear combination of factors derived from characteristics of the shape.

In some implementations a shape selection score is based on geometric features of the shape. For example, large shapes may be preferred by basing the score on the area of a shape. In some implementations, shapes with right angles may be preferred. For example, a score may be based on the extent to which angles at vertices of the shape deviate from π2.

It may be useful to overlay content items on certain types of geographic features depicted in a map (e.g., bodies of water, parks, wilderness areas, or empty space between depicted features) because these geographic features may be considered less significant by users. A shape selection score may be based on one or more features reflecting the geographic feature type of a shape. For example, a shape selection score may be based on a color feature of a shape or a texture feature of a shape. For example, a polygon with the color feature ‘blue’ may represent a body of water. Where water is considered a relatively insignificant geographic feature, shapes with the color feature ‘blue’ may be assigned high shape selection scores (where a high shape selection score indicates that a shape is more suitable for content item overlay than another shape with a low shape selection score). In some implementations, a shape occurring in the map may have a type parameter associated with it (e.g., indicating the shape represents water, park, or establishment grounds). A shape selection score may be based in part on a type parameter. For example, the shape selection score may be increased for a shape with a type parameter set to “water”, “park”, or “desert”, while the shape selection score may be decreased for a shape with a type parameter set to “golf course” or “establishment grounds”.

In some implementations, a metric indicating the position of a shape in the requested map relative to the center of the map or to an edge of the map is determined. A shape selection score may be based in part on the position metric (e.g., a radial distance from the center). For example, shapes near the edges of a map may be preferred to reduce user annoyance that may be caused by the overlay of content items in the map. Using the position metric, the selection may be biased for the selection of shapes positioned near an edge of the map. In some implementations, shapes with more prominent or central positions in the map may be preferred to increase the chance of a user recognizing an overlaid content item.

In some implementations, a shape is selected 220 after a content item has been chosen for integration into the map. In these cases, the geometric dimensions of a display feature of the content item may be considered in selecting the shape to which the content item will be snapped. A shape selection score may be based in part on a comparison of the geometric features of the content item (e.g., the dimensions of its creative) to geometric features of the shape in the map. Geometric features may be compared by determining a metric for the fit between a creative and a shape in a map. For example, the ratio of the area of the creative to the area of shape when the creative is maximally sized to fit within the shape may be used as a metric of the fit.

In some implementations, shapes to which content items may be snapped are dynamically identified and selected 220 in response to the request for a map.

In some implementations, candidate shapes in a map may have been identified before a request for a particular map occurs. For example, shapes that correspond to specific geographic or architectural features (e.g., bodies of water or walls of buildings) that are depicted by a mapping system may be bid on by interested parties (e.g., advertisers 108) before user requests are received. When a map request is received, a standing bid on a previously identified shape in the map may be used to select 220 a shape for overlay. These shapes with standing bids or reserved display rights may be referred to as a virtual billboard location. Records for identified virtual billboards reflecting standing bids or other status information may be maintained in a data storage device (e.g., storage device 406) and accessed when a request for a map is received.

The shape to which a content item may be snapped may be selected 220 by the map rendering module 112 of the map server system 110. In some implementations, the shape may be selected 220 by a map rendering module operating on a user device 106.

A content item may be selected 230 for integration into the requested map. The content item may describe something other than a place in a geographic region depicted in the map. For example, where a request for a map includes a search query for “hotels,” an advertisement for a hotel search service that is not tied to a particular location in depicted in the map may be selected for integration into the map.

In some implementations, a content item is selected from among a set of candidate content items based on a comparison of quality scores. For example, the candidate content item with the highest predicted click through rate when paired with the impression associated with the shape in the requested map may be selected.

In some implementations, selecting a content item for integration in the map includes running an auction for the available display space (e.g., the selected shape). A content item with the highest bid may be selected. In some implementations, an effective bid may depend in part on a quality score for the pairing of the content item and the requested map. For example, a bid may be specified as an amount that will be paid for a conversion.

In some implementations, a content item is selected 230 after a shape has been chosen for overlay. In these cases, the geometric features of the shape may be considered in selecting the content item that will be snapped to the shape. A content item selection score may be based in part on a comparison of the geometric features of the content item (e.g., the dimensions of its creative) to geometric features of the shape in the map. Geometric features may be compared by determining a metric for the fit between a creative and a shape in a map. For example, the ratio of the area of the creative to the area of shape when the creative is maximally sized to fit within the shape may be used as a metric of the fit.

For example, the content item may be selected 230 by the allocation module 130 of the advertisement management system 120. In some implementations, the content selection is performed by a remote server and a computing device (e.g., map server system 110 or user device 106) that implements the shape selection and rendering of the map receives the selected content item over a network 102 through a network interface (e.g., communication interface 466).

A content item may be scaled 240 to fit the selected shape. In some implementations, a creative for the content item is scaled to fit completely within the selected shape. For example, a creative for the content item may be scaled to the largest size that will fit completely within the selected shape. In this manner, the display size of the content item may be increased without substantially increasing the chance of obstructing significant features of the map. In some implementations, a creative may be scaled to be bigger than the selected shape in one or more dimensions. For example, if the selected shape is smaller than a minimum required display size for a creative, the minimum display size may be utilized for the map.

A content item may be scaled 240 by the map rendering module 112 of the map server system 110. In some implementations, the content item may be scaled 240 by a map rendering module operating on a user device 106.

A content item may be aligned 250 with the selected shape. Shapes occurring in a map may have various orientations. The edges of the shape may run at various angles with respect to the edges of the map. In 3-D maps, there may also be a tilt parameter associated with a shape that helps to achieve the perception of a 3-D perspective on the places depicted in a map. In order to align a content item to the shape, a visual component of the content item (e.g., a creative) may be oriented to match the orientation of the shape. In some implementations, a visual component of a content item may be rotated to align one of its edges as closely as possible to an edge of a shape selected for overlay, subject to constraints designed to preserve legibility of the visual component. An example, an alignment operation in 2-D map may be constrained to ensure that the text is no more than 90 degrees rotated from an edge of the map display. In another example, am alignment in a 3-D map may be constrained to ensure a visual component is never tilted more than approximately 45 degrees away from the camera view angle.

A content item may be aligned 250 by the map rendering module 112 of the map server system 110. In some implementations, the content item may be aligned 250 by a map rendering module operating on a user device 106.

The map may be rendered 260 with a visual component (e.g., creative) of the content item projected onto the shape. A projection operation may be performed to overlay a creative onto a surface defined by the shape in the map. In some implementations, the result of the rendering is map data (e.g., a rasterized image or a set of instructions for producing a rasterized image) that includes a scaled and aligned visual component of the content item. In some implementations, the result of rendering is map data that includes instructions for integrating a visual component of a content item into place within the map. For example, where a content item is sent directly from a separate advertisement server to a user device and map data is sent from a map server to the user device, the map data may include instructions identifying the shape onto which a creative of the content item should projected. The map data may also include scale and orientation parameters for the content item.

A map may be rendered 260 by the map rendering module 112 of the map server system 110. In some implementations, the map may be rendered 260 by a map rendering module operating on a user device 106.

Map data may be transmitted 270 in response to the request for presentation of the map to a user. For example, the map data may be transmitted 270 to a user device (e.g., user device 106) over a network (e.g., network 102). The map data may be transmitted using a network interface (e.g., server system interface components of the map server system 110). In some implementations, where the process 200 is mostly or entirely performed by a client device (e.g. user device 106), the map may be directly presented to a user via a display interface (e.g., display interface 456 coupled to a display 454).

### Example Maps

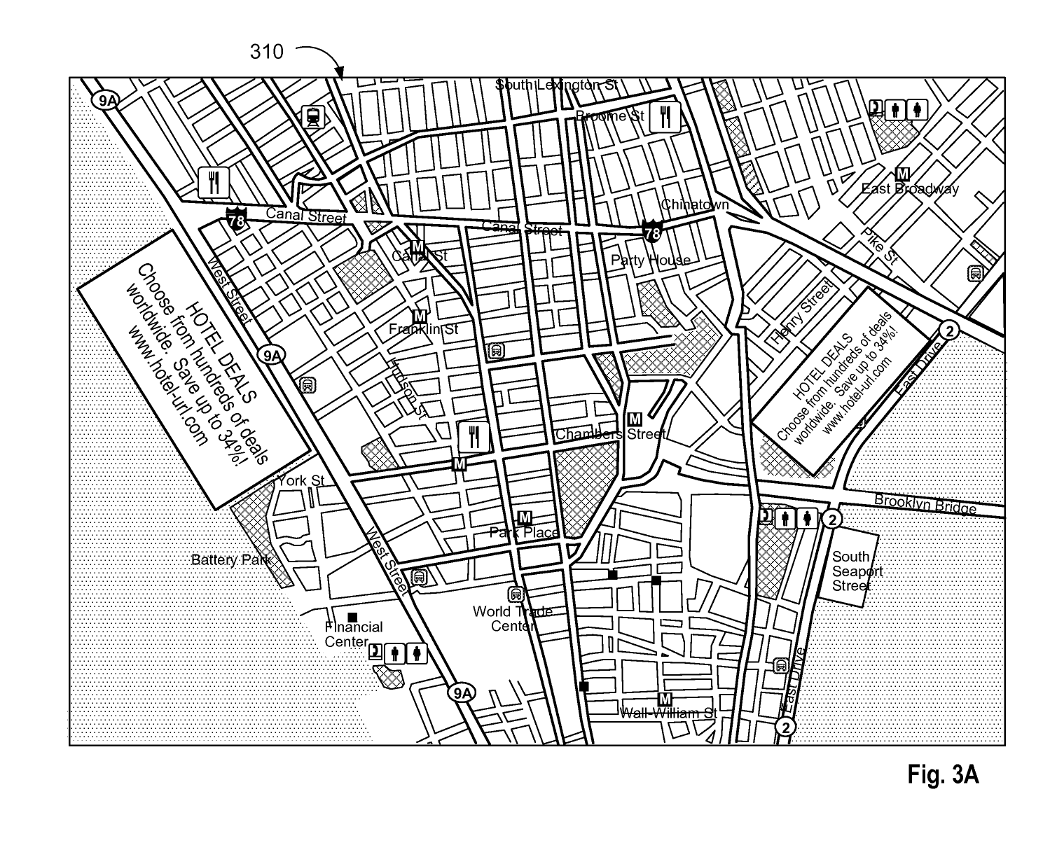

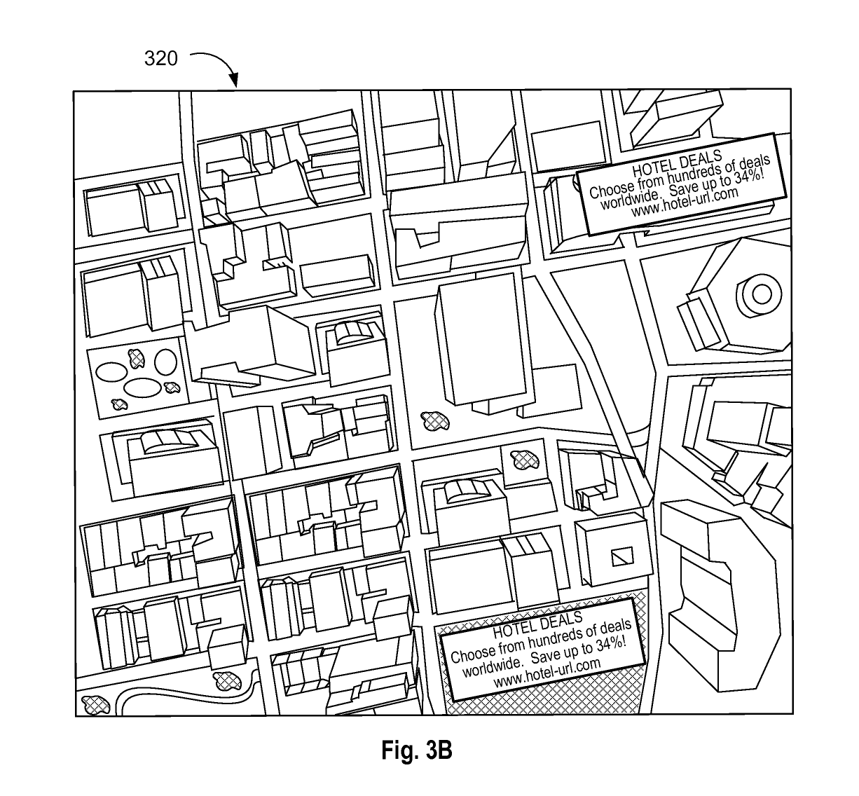

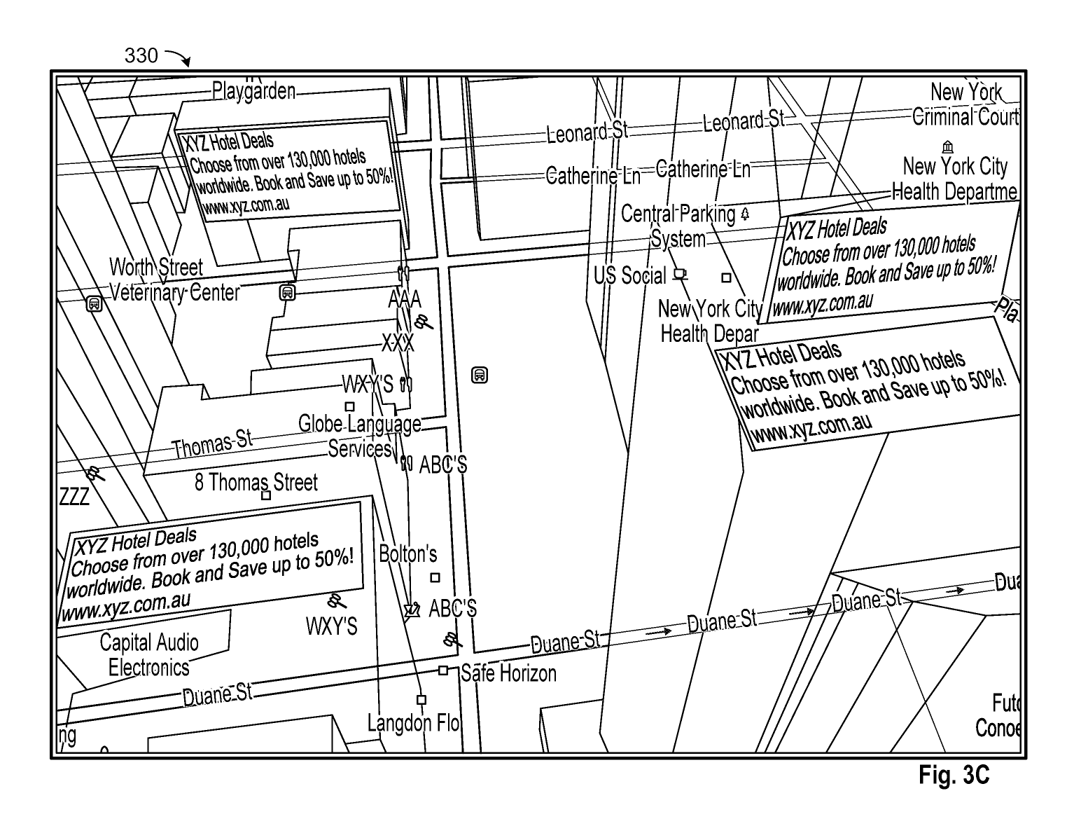

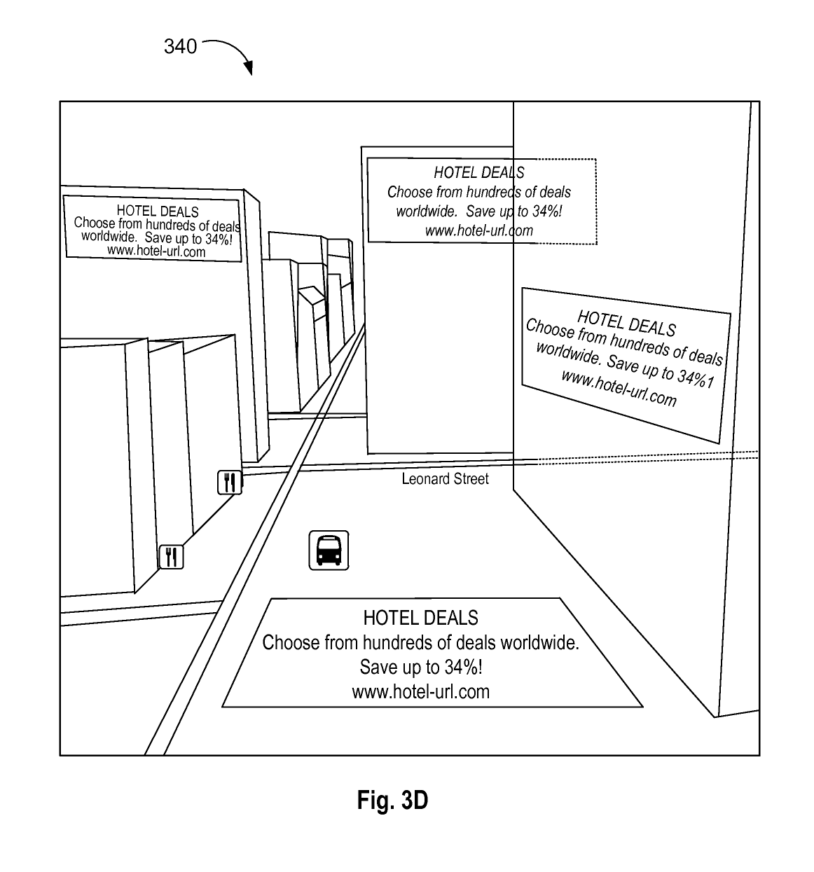

FIG. 3A shows an example map 310 that may be generated using process 200. Map 310 is 2-D map depicting an urban region with rivers running along two of its sides. Two content items, both advertising the hotel search service “HOTEL DEALS,” have been integrated into map 310. The first content item has been snapped to a blue polygon (the color blue is represented by a fine dot pattern in the figure) representing a portion of river on the left side of the map, just off the shore. The second content item has been snapped to a space in the lower right portion of the map defined by four major roads (i.e., roads represented with thicker lines in the figure) that surround it. The space includes less significant roads (i.e., roads represented with thinner lines in the figure). The depictions of these less significant geographic features have overlaid with the creative for the second content item. In some implementations, features in the map are assigned to a hierarchy reflecting the relative significance of the features. The hierarchy may be used to determine which features may be ignored when identifying shapes consisting of space between features of higher priority. For example, a hierarchy for roads depicted in a map may be defined, e.g., highways first (highest significance in the hierarchy), then arterial roads, then local roads, then terminal roads, then footpaths.

FIG. 3B shows an example map 320 that may be generated using process 200. Map 320 is a 3-D map of an urban region with zero tilt perspective (i.e., the region is viewed from directly above). Buildings in the region are depicted as 3-D objects with outer surfaces including walls and roofs. Two content items, both advertising the hotel search service “HOTEL DEALS,” have been integrated into map 320. The first content item has been snapped to a large roof of a building in the upper right corner of the map. The second content item has been snapped to a large green polygon (the color green is represented by a cross-hatch pattern in the figure) representing a portion of a park at the bottom of the map. In selecting shapes for overlay, large rectangular shapes near the edges of the map have been favored.

FIG. 3C shows an example map 330 that may be generated using process 200. Map 330 is a 3-D map of an urban region with 45° tilt perspective (i.e., the region is viewed from a 45° angle to the vertical). Four content items, all advertising the hotel search service “XYZ Hotel Deals,” have been integrated into map 330. The first content item has been snapped to a wall of a building in the upper left corner of the map. The second content item has been snapped to a roof of a building in the lower left corner of the map. The third content item has been snapped to a portion of a roof near the right edge of the map. The fourth content item has been snapped to a wall near the right edge of the map. Surfaces with geometries that match the creative for the content items have been favored. Surfaces with orientations that facilitate readability of the creative, i.e. a close to vertical orientation of the creative when snapped, have also been favored. Surfaces near the edges of the map have also been favored during shape selection.

FIG. 3D shows an example map 340 that may be generated using process 200. Map 340 is a 3-D map of an urban region with 90° tilt perspective (i.e., the region is viewed from a 90° angle to the vertical). Four content items, all advertising the hotel search service “HOTEL DEALS,” have been integrated into map 340. The first content item has been snapped to a wall of a building in the upper left corner of the map. The second content item has been snapped to a wall of a building near the center of the top edge of the map. The third content item has been snapped to a wall near the center of the right edge of the map. The fourth content item has been snapped to a space on the ground in the center of the map between two roads and a building. Surfaces with geometries that match the creative for the content items have been favored. Surfaces with orientations that facilitate readability of the creative, i.e. a close to vertical orientation of the creative when snapped, have also been favored.

### Example System Implementations

FIG. 4 is a block diagram of computing devices 400, 450 that may be used to implement the systems and methods described in this document, as either a client or as a server or plurality of servers. Computing device 400 is intended to represent various forms of digital computers (e.g., laptops, desktops, workstations, personal digital assistants, a television with one or more processors embedded therein and/or coupled thereto, servers, blade servers, mainframes, and other appropriate computers). Computing device 450 is intended to represent various forms of mobile devices (e.g., personal digital assistants, cellular telephones, smartphones, tablet computing devices, and other similar computing devices). The components shown here, their connections and relationships, and their functions, are meant to be exemplary only, and are not meant to limit implementations described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, e.g., display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, e.g., those described above. The information carrier is a computer- or machine-readable medium (e.g., the memory 404, the storage device 406, memory on processor 402, or a propagated signal).

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices (e.g., a keyboard, a pointing device, a scanner, or a networking device). Networking devices may include, for example, a switch or router, which may be accessed through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer, e.g., a laptop computer 422. Alternatively, components from computing device 400 may be combined with other components in a mobile device (not shown), e.g., device 450. Each of such devices may contain one or more of computing device 400, 450, and an entire system may be made up of multiple computing devices 400, 450 communicating with each other.

Computing device 450 includes a processor 452, memory 464, an input/output device (e.g., a display 454), a communication interface 466, and a transceiver 468, among other components. The device 450 may also be provided with a storage device (e.g., a microdrive or other device) to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450. Other components of the device 450 may include, for example, control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication (e.g., using a docking procedure) or for wireless communication (e.g., using Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided by using the SIMM cards, along with additional information, e.g., placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, e.g., those described above. The information carrier is a computer- or machine-readable medium (e.g., the memory 464, expansion memory 474, memory on processor 452, or a propagated signal).

Device 450 may communicate wirelessly through communication interface 466, which may include digital signal processing circuitry where necessary. Communication interface 466 may provide for communications under various modes or protocols, including GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, for example, using a Bluetooth, WiFi, or other such transceiver (not shown). In addition, GPS receiver module 470 may provide additional wireless data to device 450, which may be used as appropriate by applications running on device 450.

Device 450 may also facilitate communication audibly using audio codec 460, which may receive spoken information from a user and convert it to usable digital information. Audio codex 460 may likewise generate audible sound for a user through a speaker, e.g., in a handset of device 450. Such sound may include sound from voice telephone calls, may include recorded sound (e.g., voice messages, music files, etc.), and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

The map server system and the advertisement management system can be realized by instructions that upon execution cause one or more processing devices to carry out the processes and functions described above. Such instructions can comprise, for example, interpreted instructions or other instructions stored in a computer readable medium. Interpreted instructions may include, for example, executable code or script instructions (e.g., JavaScript or ECMAScript instructions). The map server system and the advertisement management system can be distributively implemented over a network (e.g., as a server farm) or can be implemented in a single computer device.

Although example processing systems have been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “processing system” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

For situations in which the systems discussed herein collect personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (for example, to a city, zip code, or state level), so that a particular location of the user cannot be determined.

The processes described herein and variations thereof contain functionality to ensure that party privacy is protected. Likewise, the processes may be programmed to confirm that information about a party is publicly known before divulging that information to another party even before incorporating that information into a social graph.

Elements of different implementations described herein may be combined to form other implementations not specifically set forth above. Elements may be left out of the processes, computer programs, Web pages, etc. described herein without adversely affecting their operation. In addition, the logic flows depicted in the figures do not require the particular order shown, or sequential order, to achieve desirable results. Various separate elements may be combined into one or more individual elements to perform the functions described herein.

Other implementations not specifically described herein are also within the scope of the following claims.

What is claimed is:

1. A computer-implemented method for generating a map, the method comprising:
receiving, using one or more data processing apparatuses, a request for an online map;
selecting, using one or more data processing apparatuses, a shape in the online map to accommodate overlay of a content item, wherein the shape is selected based on a score computed based on, at least in part, comparing geometric features of the content item with geometric features of the shape;
scaling, using one or more data processing apparatuses, the content item to fit the shape;
aligning, using one or more data processing apparatuses, the content item with an edge of the shape;
rendering, using one or more data processing apparatuses, the map with the content item projected onto the shape; and
transmitting, using one or more data processing apparatuses, data encoding the rendered map in response to the request.

2. The method of claim 1, wherein the content item describes something other than a place in a geographic region depicted in the map.

3. The method of claim 1, further comprising selecting, using one or more data processing apparatuses, a content item for integration into the online map.

4. The method of claim 3, wherein selecting the content item comprises running an auction.

5. The method of claim 3, wherein selecting the content item comprises selecting the content item at least in part based on a display feature of the content item and a geometric feature of the shape.

6. The method of claim 1, wherein the score is based on a display feature of the content item.

7. The method of claim 1, wherein selecting the shape comprises selecting a shape that has been previously identified as virtual billboard location.

8. (canceled)

9. The method of claim 1, wherein the score is based at least in part on color or texture features of the shape.

10. The method of claim 1, wherein the score is based at least in part on a position of the shape within the online map.

11. The method of claim 1, wherein selecting the shape comprises biasing for the selection of shapes positioned near an edge of the online map.

12. A computer-implemented method for generating a map, the method comprising:
transmitting, using one or more data processing apparatuses, a request for an online map;
selecting, using one or more data processing apparatuses, a shape in the online map to accommodate overlay of a content item, wherein the shape is selected based on a score computed based on, at least in part, comparing geometric features of the content item with geometric features of the shape;
receiving, using one or more data processing apparatuses, the content item for integration into the online map;
scaling, using one or more data processing apparatuses, the content item to fit the shape;
aligning, using one or more data processing apparatuses, the content item with an edge of the shape;
rendering, using one or more data processing apparatuses, the map with the content item projected onto the shape; and
presenting, using one or more data processing apparatuses, the map to a user.

13. The method of claim 12, wherein the content item describes something other than a place in a geographic region depicted in the map.

14. The method of claim 12, wherein selecting the shape comprises selecting a shape that has been previously identified as virtual billboard location.

15. (canceled)

16. The method of claim 12, wherein the score is based at least in part on color or texture features of the shape.

17. The method of claim 12, wherein the score is based at least in part on a position of the shape within the online map.

18. The method of claim 12, wherein selecting the shape comprises biasing for the selection of shapes positioned near an edge of the online map.

19. A system, comprising:
one or more data processing apparatus; and
memory having instructions stored thereon which, when executed by the data processing apparatus cause the data processing apparatus to perform operations comprising:
receiving a request for an online map;
selecting a shape in the online map to accommodate overlay of a content item, wherein the shape is selected based on a score computed based on, at least in part, comparing geometric features of the content item with geometric features of the shape;
scaling the content item to fit the shape;
aligning the content item with an edge of the shape;
rendering the map with the content item projected onto the shape; and
transmitting data encoding the rendered map in response to the request.

20. The system of claim 19, wherein the content item describes something other than a place in a geographic region depicted in the map.

21. A system, comprising:
one or more data processing apparatus; and
memory having instructions stored thereon which, when executed by the data processing apparatus cause the data processing apparatus to perform operations comprising:
transmitting a request for an online map;
selecting a shape in the online map to accommodate overlay of a content item, wherein the shape is selected based on a score computed based on, at least in part, comparing geometric features of the content item with geometric features of the shape;
receiving a content item for integration into the online map;
scaling the content item to fit the shape;
aligning the content item with an edge of the shape; and
rendering the map with the content item projected onto the shape.

22. The system of claim 21, wherein the content item describes something other than a place in a geographic region depicted in the map.

23. A system, comprising:
a server system interface configured to receive a request for an online map;
a module comprising one or more processing devices, the module configured to select a shape in the online map to accommodate overlay of a content item, wherein the shape is selected based on a score computed based on, at least in part, comparing geometric features of the content item with geometric features of the shape;
a module comprising one or more processing devices, the module configured to scale a content item to fit the shape;
a module comprising one or more processing devices, the module configured to align the content item with an edge of the shape;
a module comprising one or more processing devices, the module configured to render the map with the content item projected onto the shape; and
a server system interface configured to transmitting data encoding the rendered map in response to the request.

24. The system of claim 23, wherein the content item describes something other than a place in a geographic region depicted in the map.

25. A mobile computing device, comprising:
a wireless network interface configured to transmit a request for an online map;
a module comprising one or more processing devices, the module configured to select a shape in the online map to accommodate overlay of a content item, wherein the shape is selected based on a score computed based on, at least in part, comparing geometric features of the content item with geometric features of the shape;
a wireless network interface configured to receive a content item for integration into the online map;
a module comprising one or more processing devices, the module configured to scale the content item to fit the shape;
a module comprising one or more processing devices, the module configured to align the content item with an edge of the shape;
a module comprising one or more processing devices, the module configured to render the map with the content item projected onto the shape; and
a display interface configured to present the map to a user.

26. The mobile computing device of claim 25, wherein the content item describes something other than a place in a geographic region depicted in the map.

27. The method of claim 1, wherein comparing the geometric features of the content item with the geometric features of the shape comprises calculating a metric based on dimensions of the content item and the shape.

28. The method of claim 27, wherein the metric is a function of a ratio of an area of the content item to an area of shape.
